(19) United States
(12) Patent Application Publication
(10) Pub. No.: US 2004/0191020 A1
(43) Pub. Date: Sep. 30, 2004

(54) Method and apparatus for a boring bar and kelly valve

(76) Inventor: Kevin M. Klipstein, Lafayette, LA (US)

Correspondence Address: William H. Holt, 12311 Harbor Drive, Woodbridge, VA, 22192, US

(21) Appl. No.: 10/810,854

(22) Filed: Mar. 29, 2004

Related U.S. Application Data
(60) Provisional application No. 60/457,582, filed on Mar. 27, 2003.

(51) Int. Cl. B23B 51/00

(52) U.S. Cl. 408/225

(57) ABSTRACT

An elongated kelly valve for use in well drilling equipment is manufactured by a method utilizing a novel drill bar that bores a stepped opening in the valve material in a single operation and with improved accuracy.

### BACKGROUND OF THE INVENTION

It is known in the oil well drilling industry to provide a one-piece kelly valve wherein conventional manufacturing processes provide such valves having a length of from about 9.5 inches to 13 inches between an upper connection to a valve stem hole.

With traditional one-piece kelly valve manufacturing processes, utilizing the tool shown in FIG. 3, a cantilevered, single point cutter boring bar has been used. The boring bar is attached in a lathe tool post and extends out from the tool post the necessary distance to allow the kelly valve bore to be cut to a specified dimension, or depth. The amount of material removed in a single pass with the known boring bar is limited to the depth that the single point cutter can be fed into the stock material. The single point cutter boring bar is cantilevered from the tool post and makes single point contact with the metal being cut. The diameter of the boring bar controls the rigidity of the boring bar and ultimately controls how far the boring bar can be extended from the lathe tool post. Also, the diameter of the bore, or hole, in the kelly valve material controls the maximum diameter of the boring bar that can be used. Therefore, the length that can be bored inside one-piece kelly valves is limited by the rigidity of and the physical diameter of the conventional boring bar.

### SUMMARY OF THE INVENTION

The present invention provides for a one-piece kelly valve and increasing the length between the upper connection and the valve stem hole by a factor of 2 to 3 times the current standard length of 9.5 to 13 inches for the conventional kelly valve.

The improvement provides the following advantages:

1. The life of the valve is significantly increased by allowing more connection repairs, including the recutting of worn threads.

2. The extended length of the valve and position of the valve stem hole allows easier accessibility below the drilling equipment in the derrick when the valve needs to be opened and closed.

3. On certain drilling equipment, the extended length of the valve and position of the stem hole allows the valve to be installed, i.e., made up to the drilling equipment, in a shorter period of time as compared with conventional length one-piece kelly valves.

4. The extended length, one-piece kelly valve allows extension subs to be eliminated on certain drilling hardware configurations, thereby saving drilling rig time.

### BRIEF DESCRIPTION OF THE DRAWINGS

FIG. 1 is a schematic of an oil derrick and shows the location of the novel, extended length, kelly valve in the drilling stem.

FIG. 2 is an enlarged representation showing parts of the drilling hardware with respect to the location of the kelly valve.

FIG. 3 is a fragmentary cross-sectional view of a boring bar setup which exemplifies the Prior Art.

FIG. 4 is an elevational view showing a drilling bar in accord with the present invention.

FIG. 5 is a fragmentary cross-sectional view of the drilling bar in accord with the present invention located in operative position for drilling a bore within stock material for a kelly valve.

### DESCRIPTION OF THE PREFERRED EMBODIMENTS

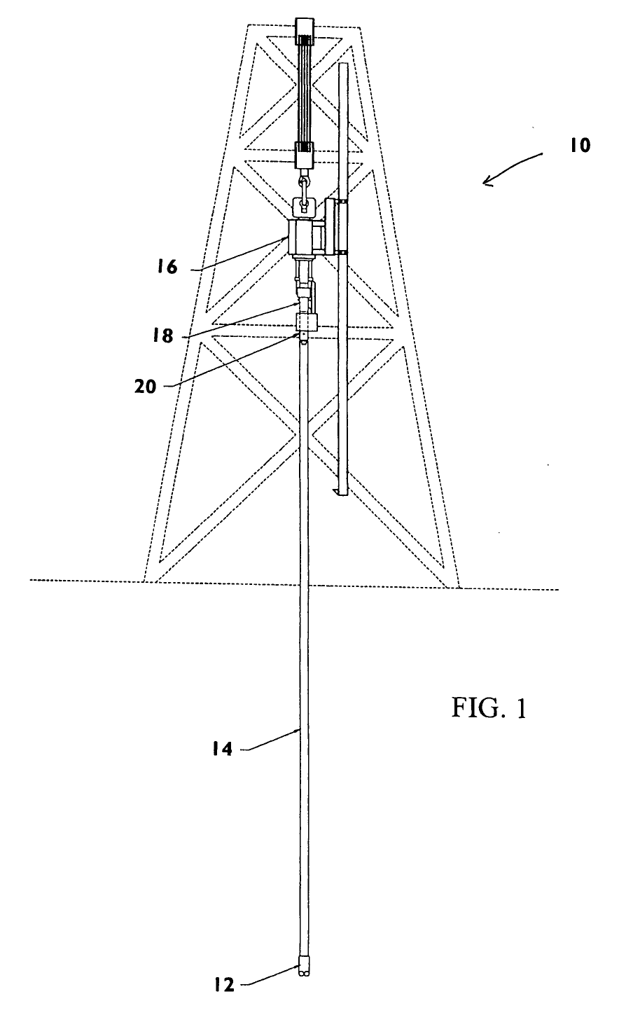

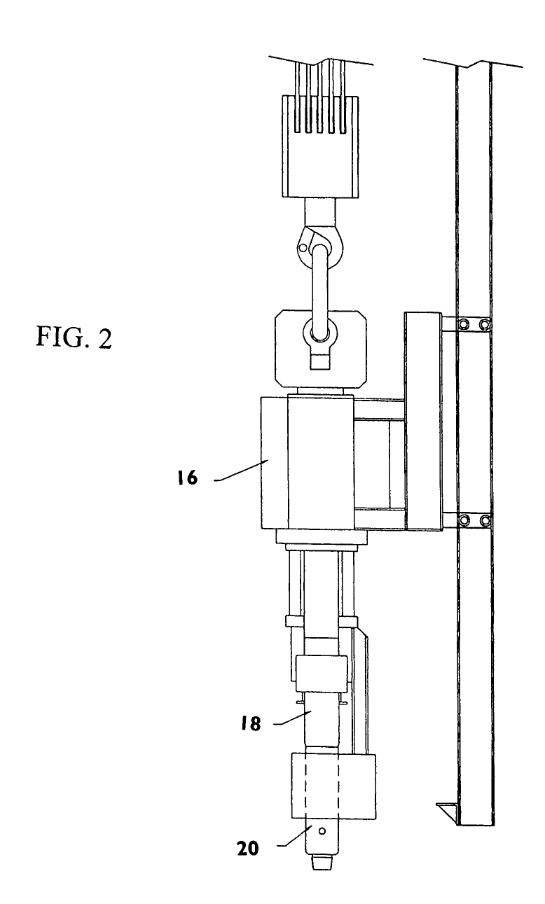

FIG. 1 shows a drilling derrick, generally indicated by the numeral 10, typically used in drilling for oil or water. A drill bit 12 is carried at the lower end of a drill stem 14 which depends from conventional drilling hardware 16 including a top drive or other hardware. FIG. 2 illustrates in larger detail that located below drilling hardware 16 is a conventional upper valve 18 and depending therefrom is an extended length kelly valve 20 formed in accord with the present invention which will hereinafter be further described.

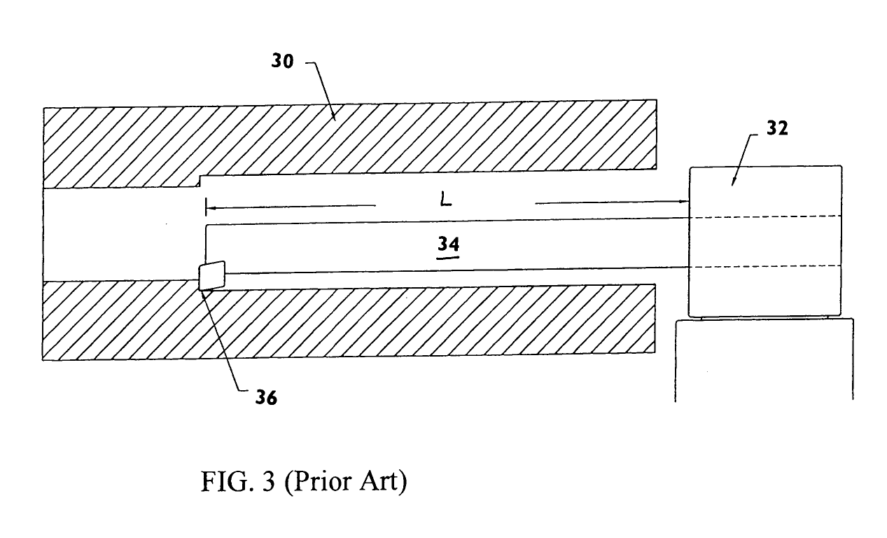

In order to more completely understand the invention, attention is directed to FIG. 3 which illustrates the prior art wherein a partially drilled kelly valve 30 is being formed with a conventional lathe tool post 32 cantilevered from which is a boring bar 34 having a length L and terminating at a single point cutter 36. It is readily seen that the diameter of the boring bar 34 controls its rigidity and it length L determines the determines the depth of cut. As mentioned above, the diameter of the bore, or hole being formed by cutter 36 controls the maximum diameter of the boring bar 34. As a result of the limitation on the diameter of the boring bar 36, its length L is also limited in order to have the requisite strength needed for boring the desired bore diameter.

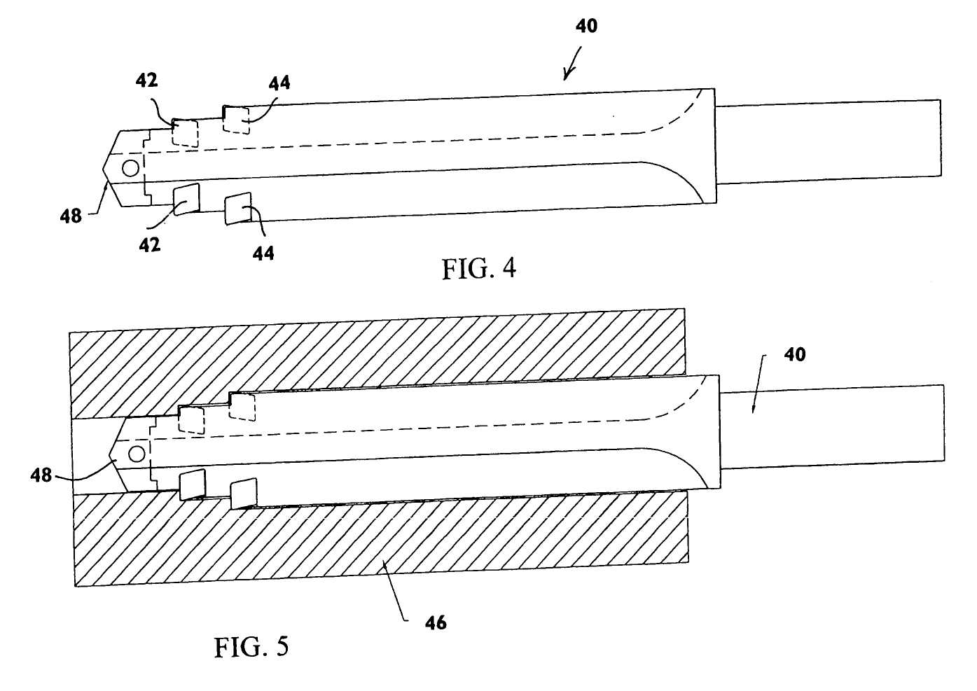

The present invention comprises an improved lathe drilling bar and manufacturing process utilizing a novel drilling bar, generally indicated by the numeral 40 and shown in FIGS. 4 and 5. Multiple sets of cutter heads 42, 42 and 44, 44 are positioned on stepped diameters of the drilling bar 40 and are used to drill the internal bore of the kelly valve. The sets of cutter heads 42, 42 and 44, 44 include multiple, single-point cutters positioned around the cutter head so that the cutting forces are balanced. It is to be noted that the single-point cutter contact on each cutter head 42 and 42, and 44 and 44, eliminates the cantilever effect of the heretofore traditional boring bar 34 of FIG. 3 and acts to centralize the drilling bar 40 inside the bore of the kelly valve 46. The plurality of cutting heads 42, 42 and 44, 44 are positioned on progressively larger, stepped, diameters of the drilling bar, as is shown in FIGS. 4 and 5. The stepped cutter heads thereby provide for progressively forming the bore of the valve 46 for forming the desired minimum and maximum diameters. As a result, the bore of the improved kelly bar 46 is completed in a single machine cycle, and the balanced cutting forces provide for greater accuracy and extended length than in the prior art equipment. It is also to be noted that the diameter of drilling bar 40 is nearly as large as the diameter of the bore, whereas the diameter of the prior art boring bar 34, in FIG. 3, is less than one-half the bore diameter in kelly valve 30. A conventional spade drill 48 is located at the leading edge of the drilling bar 40 in a known manner.

The advantages of the improved manufacturing process using the improved drilling bar, include:

1. The length from the top connection to the valve stem hole can be increased by a factor of 2 to 3 because of the greater rigidity of boring bar 40 inherent in its larger diameter allowing for a larger length.

2. Manufacturing time is reduced because of the ability to form plural bores with differing diameters with a single pass of the drilling bar and,

3. Manufacturing tolerance control and accuracy are improved because of the improved strength of the drilling bar 40 as compared to the prior art drilling bar 34.

These and other advantages and improvements over the prior art will be appreciated by persons skilled in the art in view of the foregoing description of the preferred embodiment of the present invention, and it is to be understood that various changes and modifications are possible within the scope of the following claimed subject matter.

I claim:

1. A drilling bar for forming a valve, said bar comprising a first set of cutter heads spaced about a first diameter of said bar and a second set of cutter heads spaced about a second and larger diameter of said bar.

2. A drilling bar as defined in claim 1 wherein the cutter heads of each set are diametrically opposite from each other for balancing forces upon said drilling bar.

3. A method of forming a bore of a valve, said method comprising the steps of providing a drill bar having a first set of cutter heads spaced about a first diameter of said bar and a second set of cutter heads spaced about a second and larger diameter of said bar.

4. A method as defined in claim 3 including the step of locating the cutter heads of each set diametrically opposite from each other for balancing forces upon said drilling bar.
